(19) United States
(12) Patent Application Publication
(10) Pub. No.: US 2013/0008290 A1
(43) Pub. Date: Jan. 10, 2013

(54) Sliding hammer pull bar

(76) Inventors: Fernando Bugallo, Boca Raton, FL (US); Roberto Cid, Boca Raton, FL (US)

(21) Appl. No.: 13/135,509

(22) Filed: Jul. 7, 2011

(51) Int. Cl. B25D 1/00

(52) U.S. Cl. 81/463

(57) ABSTRACT

A tool for the installation of wood flooring, or any other flooring that has a tongue and grove design, and where space is limited for the use of larger tools. A Slide Hammer Pull Bar has a lower and upper section designed in such a manner that will not damage flooring boards when it is used to tap the boards into place. The invention includes a base lower section that has a sliding track, and a weighted hammer upper section, movable along the slide base track of the lower section. With a lower vertical extension in contact with a board, the hammer is moved into contact with the solid end of the lower section in a vigorous manner to drive the board into place. The invention is designed and configured so as to allow the unit to be positioned in tight spaces between the boards and any surrounding walls.

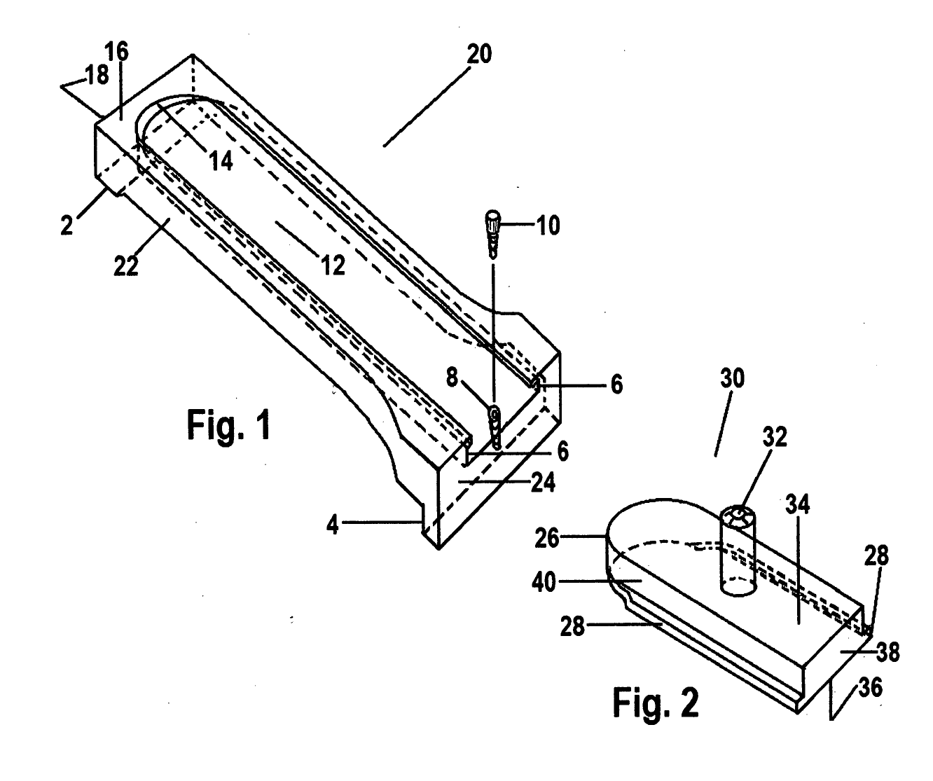

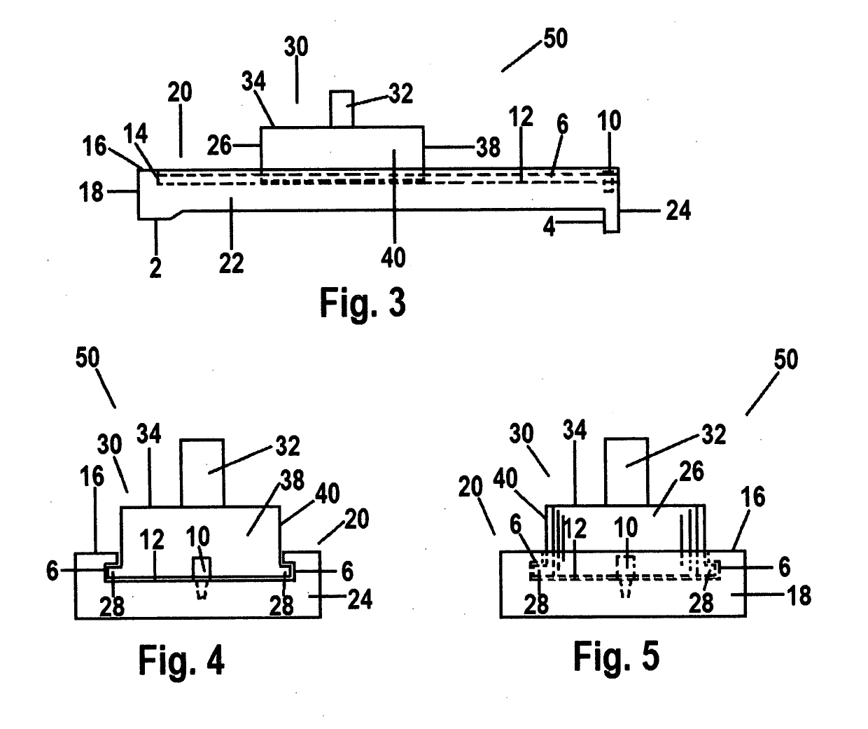

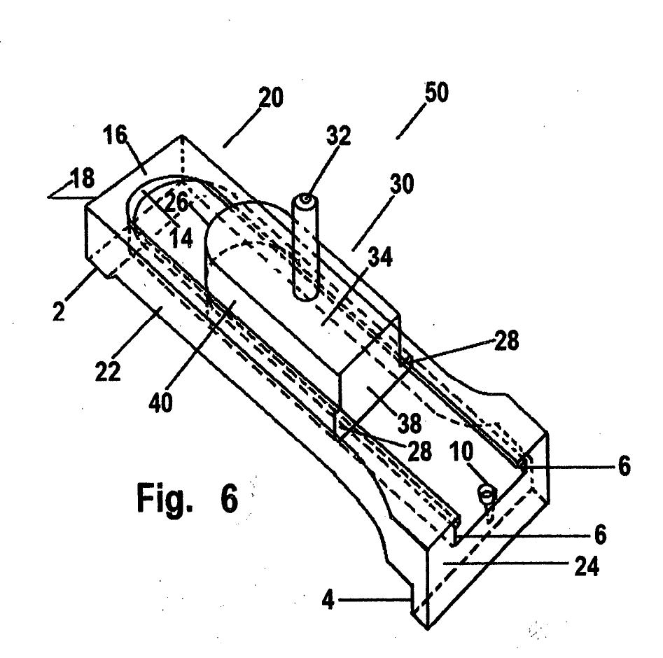

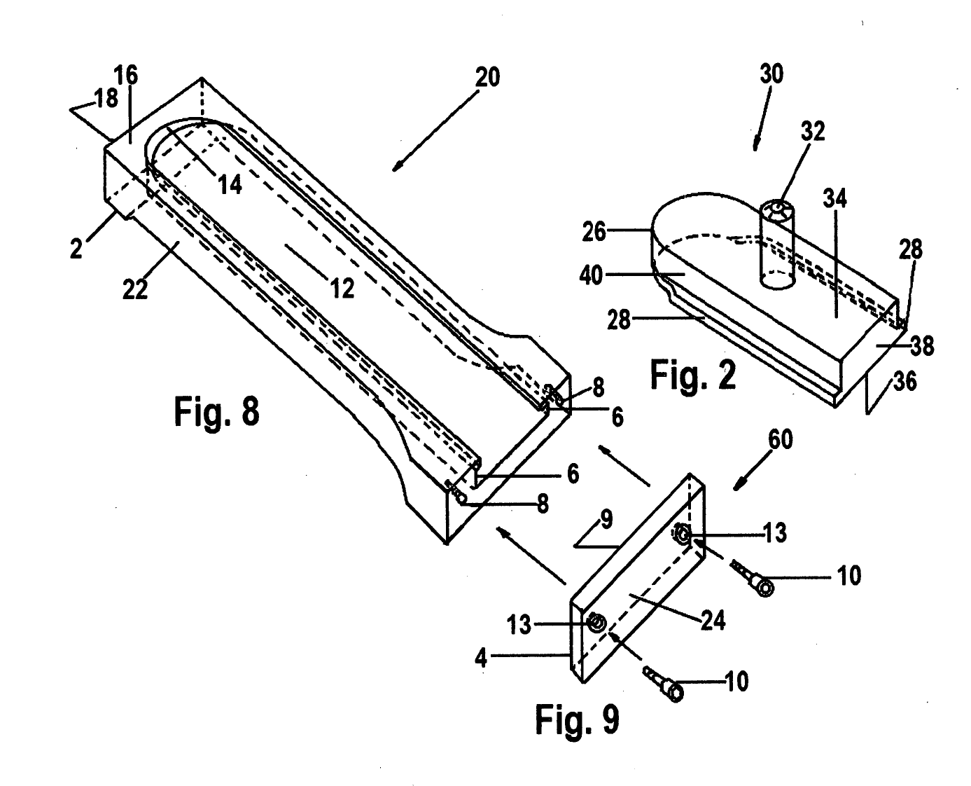

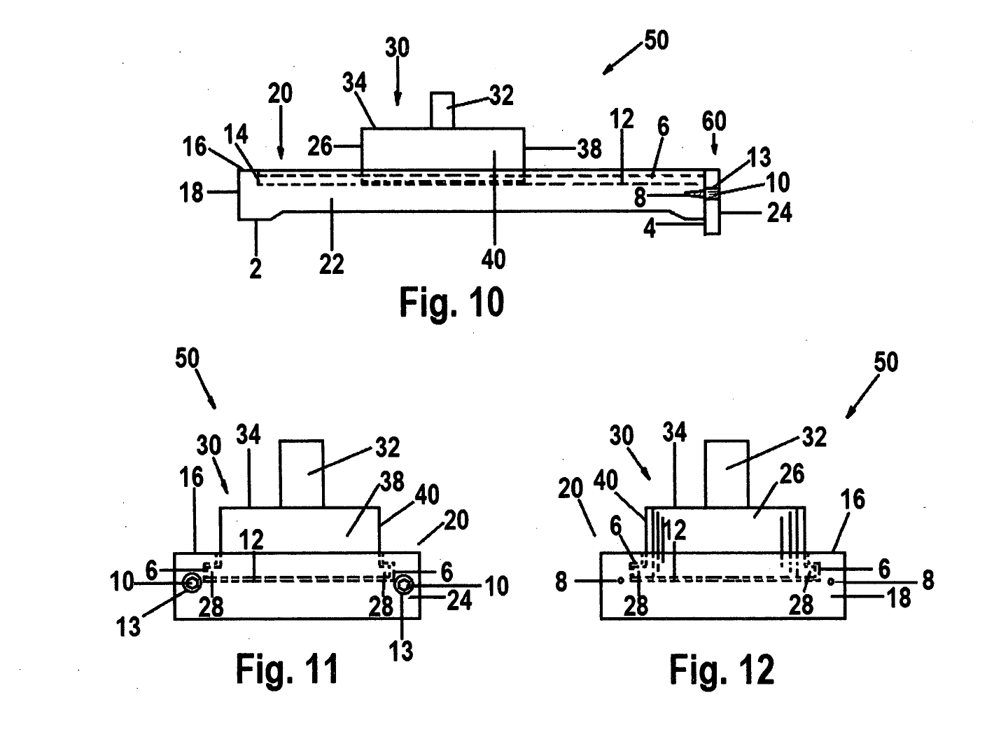

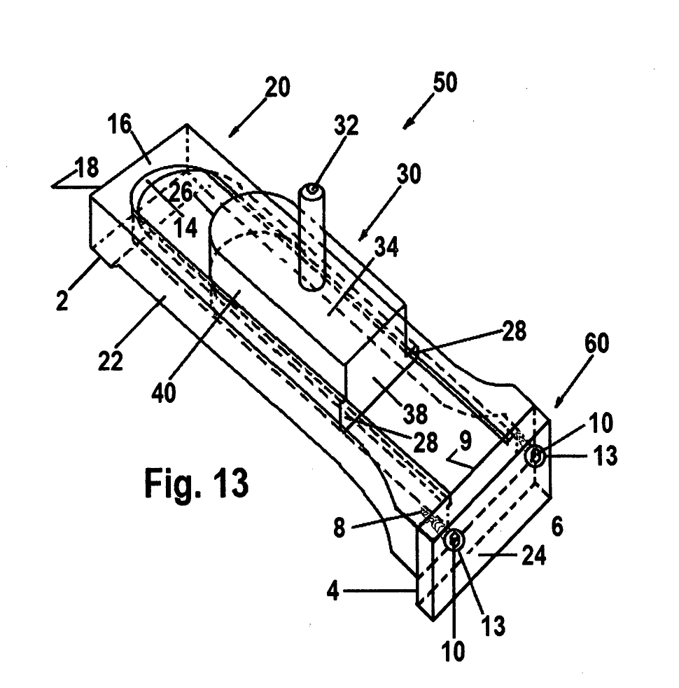

### BACKGROUND OF THE INVENTION

1. Field of the Invention

This invention relates generally to slide hammers, and more particularly to a slide hammer of special configuration for tapping tongue-in-groove boards into place.

2. Description of Related Art

The following art defines the present state of this field:

Gutierrez, U.S. Pat. No. 5,461,900 describes a device for use in the repair of automobiles, trucks, farm equipment and other vehicles having sheet metal bodies capable of deformation from impact accidents. This device includes a main body portion having a first nestable solid section and a second tubular receiving section the receiving section being constrictedly open at its proximal end. The receiving section being closed on its distal end by a closure which is threaded to receive a work head of varying configurations, each of which is interchangeable with the other for carrying out specific tasks or functions within a specific area of the vehicular body.

Burrola, U.S. Pat. No. 4,624,323 describes an improved multi-purpose impact hand tool kit for use by electricians, carpenters or similar tradesperson in the building construction industry or other similar industry in applications that require the use of an impact type of hand tool for driving fastening devices such as concrete nails, threaded or unthreaded fastener studs, pins anchor/expansion plugs or similar devices. The improved impact hand tool kit conveniently provides for the tradesperson an elongated shaft provided with a tool end having exterior threads and a threaded bore for attaching male or female threaded attachment ends provided on commercially available fastening devices. The improved hand tool kit can also be used by the tradesperson in general applications that require the use of an impact or non-impact general purpose hand tools such as chisels, punches, and screwdrivers. Such impact or non-impact general purpose hand tools are specially adapted for use with the elongated shaft of the improved impact hand tool kit. The improved impact hand tool kit is also provided with simple reducer adapters which will allow the use of fastening devices or specially adapted general purpose impact or non-impact hand tools having their attachment ends with a reduced thread size. The improved impact hand tool kit is provided with features that add utility, comfort, durability and safety during its use.

Cook, U.S. Pat. No. 3,844,321 describes an impact tool in which a specifically configured skeletal stiffener is completely and unitarily encased in a thick resilient encasement. The part of the skeletal stiffener which forms the basis for the striking head of the tool may be internally provided with operatively movable and treated particles to inhibit any recoil of the head when an object is struck.

Gue, U.S. Pat. No. 3,568,647 describes an elongated rock-breaking bar providing one end with a chisel point and at the opposite end with a chisel edge. Intermediate these ends are a pair of longitudinally spaced collars between which a hammer member is mounted slidable on the bar. In one embodiment the bar is made in two detachable longitudinal sections and the hammer member is made in one piece. In another embodiment the bar is made in one piece and the hammer member is made in two detachable lateral sections.

Bonnesen, U.S. Pat. No. 2,702,060 describes a handled instrument or tool having a blow head. The tool comprises an elongated handle member which has large diameter collar inwardly of and adjacent one end thereof. A head mounted on the handle member outwardly of the collar. At the end of the handle member securing the head against displacement from the handle member is an annular bushing of sock absorbing material spacing the handle member from the head. The bushing includes shock absorbing flanges disposed between the head, collar and head securing means. The other end of the handle member has a roughened surface and a hand-grip portion of shock absorbing material fixed to the roughened surface.

White, U.S. Pat. No. 2,010,575 describes a bung-driver or hammer device of the type comprising an elongated body affording a hand-grip and having one end enlarged to form a hammer-head. The body and head being formed with an axial bore and with a coextensive open slot from end to end to permit emplacement of the hammer laterally upon a pipe. The device has a resilient cushion supported by a metal plate secured removable to the hammer-head and having a slot registering with that of the slot and bore of the handle body and further characterized by having the cushion-supporting plate provided with spaced central projections embedded in the body of the cushion, and with marginal abutment projections adjacent to the slotted end of the cushion.

The prior art teaches slide hammers of various types. However, the prior art does not teach that a slide hammer may be configured for fitting in small and large spaces as required in board laying. The present invention fulfills these needs and provides further related advantages as described in the following summary.

### SUMMARY OF THE INVENTION

The present invention teaches certain benefits in construction and use which give rise to the objectives described below.

The present invention provides a slide hammer having end blocks of a material that will not damage wooden boards when it is used to tap the boards into place. The slide hammer includes a Lower slide bar with a channel, and a weighted hammer movable within the slide channel. With one of the end blocks in contact with a board, the hammer is moved into contact with one of the end blocks in a vigorous manner to drive the boards into place. The edges of the end blocks are configured so as to allow the unit to be positioned in tight spaces between the boards and any surrounding walls.

A primary objective of the present invention is to provide a slide hammer having advantages not taught by the prior art.

A further objective is to provide such a slide hammer having a means for preventing a finger from being caught between the hammer and the end blocks by incorporating a handle on the slide Hammer.

Other features and advantages of the present invention will become apparent from the following more detailed description, taken in conjunction with the accompanying drawings, which illustrate the principles of the invention.

What is claimed is:

1. An apparatus comprising:
Of two separate sections that are paired together to form a fixed block (Lower Section)with end blocks, and a sliding weighted block (Hammer) that moves within the fixed block along a tongue and grove channel track; the hammer body having a mass density greater than the end blocks, the hammer body being mounted so as to slide within the Lower Section so as to be movable between the end blocks of the Lower Section; each of the end blocks being of a generally rectangular shape so as to provide two opposing perimeter planar edges, the planar edges laying in planes parallel to the slide Hammer; the two planar edges comprising in length, a larger one of the planar edges, and a smaller one of the planar edges; the larger one of the planar edges of the end blocks being positioned in corresponding attitudes relative to the slide Hammer so that the end blocks may be placed onto a surface with the larger one of the planar edges of the end blocks resting in contact with the surface; the smaller of the planar edges being positioned in opposing attitudes relative to the slide Hammer so that the end blocks may be placed onto a surface with the smaller one of the planar edges of the other of the end blocks simultaneously resting in contact with the surface.

2. The apparatus of claim 1 further comprises a heavy weighted Hammer slide, that sits in a grooved channel of the Lower Section, and abutting the Lower end block, as to directly receive blows of the hammer body on a distal annular rim of the Lower Section channel.

3. The apparatus of claim 2 wherein the material used to fabricate the Lower Section can be made of aluminum, steel, plastic or any other material suited for the purpose for which it is intended, and the Hammer can be made of steel, iron, plastic or any other material suited for the purpose for which it is intended.

4. The apparatus of claim 1 wherein the hammer body provides a handle attached to said Hammer body to allow for comfort of use, and to allow the user to exert the maximum sliding force.

5. The Invention of claim 1, as a new embodiment, could have a rear section that is removable by means of two set screws, so as to permit the rear section to be made in varying lengths or widths.
